(19) United States
(12) Patent Application Publication
(10) Pub. No.: US 2014/0133181 A1
(43) Pub. Date: May 15, 2014

(54) ILLUMINATION DEVICE AND DISPLAY DEVICE

(71) Applicants: Takeshi Ishida, Osaka-shi (JP); Ryuzo Yuki, Osaka-shi (JP); Yoshitsugu Kawahigashi, Osaka-shi (JP); Ichiro Umekawa, Osaka-shi (JP); Shugo Yagi, Yonago-Shi (JP)

(72) Inventors: Takeshi Ishida, Osaka-shi (JP); Ryuzo Yuki, Osaka-shi (JP); Yoshitsugu Kawahigashi, Osaka-shi (JP); Ichiro Umekawa, Osaka-shi (JP); Shugo Yagi, Yonago-Shi (JP)

(73) Assignee: SHARP KABUSHIKI KAISHA, Osaka-shi, Osaka (JP)

(21) Appl. No.: 14/232,142

(22) PCT Filed: Jun. 11, 2012
(86) PCT No.: PCT/JP2012/064877

§ 371 Date: Jan. 10, 2014

(30) Foreign Application Priority Data
Jul. 13, 2011 (JP) 2011-154486

(51) Int. Cl. F21V 8/00

(52) U.S. Cl. CPC G02B 6/0036
USPC 362/613; 362/611

(57) ABSTRACT

This illumination device (20) is provided with: a light guide plate (30) that guides the light entering from an entrance surface (30a), and radiates it from an exit surface (30b); and a frame-shaped frame (25) that supports the outer periphery of the light guide plate (30). The light guide plate (30) has: a light guide portion (35) that, in parallel along the optical axis direction (X), is provided with prisms (33) containing an inclined surface (33b) that faces and is inclined with respect to the entrance surface (30a); a low-refractive-index-layer (36) having a lower refractive index than the light guide portion (35); and a light-collecting portion (37) that is provided in parallel along the optical axis direction (X) with prisms (38) that contain an inclined surface (38b) that faces and is inclined with respect to the entrance surface (30a). The frame (25) is formed from a light absorbing material.

### TECHNICAL FIELD

The present invention relates to an illumination device provided with a light guide plate, and to a display device employing such an illumination device.

### BACKGROUND ART

A conventional display device such as a liquid crystal display device is disclosed in Patent Document 1 listed below. This display device is provided with an illumination device, which forms a backlight, and a display panel. The illumination light emitted from the illumination device illuminates the display panel to display an image.

The illumination device is provided with a light guide plate, which guides the light that has entered from a light source to emit the illumination light. The light guide plate is formed as a resin-molded member substantially in a rectangular shape as seen in a plan view which has flat surfaces on its front and rear faces. It has, on its circumferential face, an entrance face facing the light source, and has, on its front face, an exit face for the illumination light. The light guide plate has its circumferential face covered, and is thereby supported, by a light-shielding frame formed of a non-transparent resin or the like.

Under the light guide plate, a reflective sheet is arranged to face the rear face of the light guide plate, and over the exit face of the light guide plate, two prism sheets are arranged to face the exit face. The reflective sheet reflects light that leaks out through the rear face of the light guide plate back into the light guide plate.

On the top face of one of the prism sheets, a plurality of prisms extending in the optical axis direction of the light source are arranged side by side in the longitudinal direction of the entrance face. On the top face of the other of the prism sheets, a plurality of prisms extending in the longitudinal direction of the entrance face are arranged side by side in the optical axis direction of the light source. The prism sheets each make the light emerging out of the light guide plate through the exit face converge in the direction orthogonal to the ridge lines of prisms. Thus, with the two prism sheets having ridge lines orthogonal to each other, it is possible to make the illumination light converge in the direction orthogonal to the exit face, and thereby to improve brightness at the front of the exit face.

The light emitted from the light source enters the light guide plate through the entrance face. The light that has entered the light guide plate is reflected on the exit face and the rear face of the light guide plate, and is thereby guided in the optical axis direction of the light source. The guiding of the light through the light guide plate is achieved through repeated reflection such that whatever part of the light is incident on the exit face at an angle of incidence smaller than the critical angle emerges through it. The light that has emerged out of the light guide plate is made to converge by the two prism sheets in the direction orthogonal to the exit face, and then illuminates the display panel.

### LIST OF CITATIONS

### Patent Literature

Patent Document 1: Japanese Patent Application Publication No. 2009-301912 (pages 2-6, FIG. 2)

### SUMMARY OF THE INVENTION

### Problem to be Solved by the Invention

In the conventional illumination device described above, since the prism sheets have prisms formed on their top face, light that has emerged in a direction substantially orthogonal to the exit face of the light guide plate as seen in a section orthogonal to the ridge lines is reflected on both inclined surfaces of the respective prisms to travel back into the light guide plate. Thus, the light undergoes multiple reflection between the reflective sheet and the prism sheets, and much of the light emerges through the circumferential face of the light guide plate.

In particular, since the two prism sheets have ridge lines orthogonal to each other, the light that has passed through the lower prism sheet is made to converge in a direction substantially orthogonal to the exit face. This makes the light that has passed through the lower prism sheet more likely to be reflected on both inclined surfaces of the respective prisms of the upper prism sheet, causing more light to emerge through the circumferential face of the light guide plate.

Here, if the frame is formed of, for example, white resin or the like, the light that has emerged through the circumferential face of the light guide plate is reflected on the frame to travel back into the light guide plate, to be further guided through it. However, where the frame is made thin for frame width reduction, the light that has emerged through the circumferential face of the light guide plate is transmitted through the frame, causing leakage of light.

On the other hand, if the frame is formed of, for example, black resin or the like, the light that has emerged through the circumferential face of the light guide plate is absorbed in the frame. This helps make the frame thin. However, since the light that has emerged through the circumferential face of the light guide plate does not return to the light guide plate, the illumination light has reduced brightness near the frame. This inconveniently makes it difficult to reduce the size of illumination devices and hence of display devices through frame width reduction.

An object of the present invention is to provide an illumination device that allows size reduction through frame width reduction, and to provide a display device employing such an illumination device.

### Means for Solving the Problem

To achieve the above object, according to one aspect of the present invention, an illumination device is provided with: a light source; a light guide plate which has at one end face thereof an entrance face facing the light source and which guides light that has entered through the entrance face to emit illumination light through an exit face arranged at the front face of the light guide plate; and a frame which covers a circumferential face of the light guide plate. Here, the light guide plate has a light guide portion which has the entrance face and the exit face and on which first prisms including first inclined surfaces facing, with an inclination, the entrance face are arranged side by side in the optical axis direction of the light source, a low-refractive-index layer which abuts a rear face of the light guide portion and which has a lower refractive index than the light guide portion, and a light-collecting portion which is formed on the face of the low-refractive-index layer facing away from the exit face and on which second prisms including second inclined surfaces facing, with an inclination, the entrance face are arranged side by side in the optical axis direction. Furthermore, the frame is formed of a light-absorbing material.

With this structure, the light emitted from the light source enters the light guide portion of the light guide plate through the entrance face. The light that has entered the light guide portion is guided by being reflected on the exit face on the front face, and the rear face. While the light is guided through the light guide portion, reflection on the first inclined surfaces causes the angle of incidence on the exit face and the rear face to decrease gradually. Light incident on the rear face of the light guide portion at an angle of incidence smaller than the critical angle enters the low-refractive-index layer. Here, light of which the angle of incidence has become smaller than the critical angle through reflection on the first inclined surfaces enters the low-refractive-index layer; light of which the angle of incidence is greater than the critical angle is reflected on the first inclined surfaces again until its angle of incidence becomes smaller than the critical angle, when it enters the low-refractive-index layer. In this way, the angle of incidence of the light that enters the low-refractive-index layer is narrowed into a predetermined range according to the inclination angle of the first inclined surfaces. Light that has entered the low-refractive-index layer and is incident on the second inclined surfaces at an angle of incidence greater than the critical angle is reflected in the direction of the exit face, to pass through the light guide portion and emerge through the exit face. On the other hand, light that is incident on the second inclined surfaces at an angle of incidence smaller than the critical angle is refracted at the second inclined surfaces when emerging out of the light-collecting portion, to enter the light-collecting portion again; when its angle of incidence on the second inclined surfaces becomes greater than the critical angle, the light is reflected in the direction of the exit face. Light that has been guided through the light guide portion and has emerged through the circumferential face is absorbed in the frame formed of a light-absorbing material.

According to another aspect of the present invention, an illumination device is provided with: a light source; a light guide plate which has at one end face thereof an entrance face facing the light source and which guides light that has entered through the entrance face to emit illumination light through an exit face arranged at the front face of the light guide plate; a prism sheet which is arranged to face the exit face; and a frame which covers the circumferential face of the light guide plate. Here, on the light guide plate, first prisms including first inclined surfaces facing, with an inclination, the entrance face are arranged side by side in the optical axis direction of the light source. Moreover, on the prism sheet, second prisms facing the light guide plate and extending in the longitudinal direction of the entrance face are arranged side by side in the optical axis direction. Furthermore, the frame is formed of a light-absorbing material.

With this structure, the light emitted from the light source enters the light guide plate through the entrance face. The light that has entered the light guide plate is guided by being reflected on the exit face and the rear face. While the light is guided through the light guide portion, reflection on the first inclined surfaces causes the angle of incidence on the exit face and the rear face to decrease. Light incident on the exit face at an angle of incidence smaller than the critical angle emerges through the exit face. Here, light of which the angle of incidence has become smaller than the critical angle through reflection on the first inclined surfaces emerges through the exit face; light of which the angle of incidence is greater than the critical angle is reflected on the first inclined surfaces again until its angle of incidence becomes smaller than the critical angle, when it emerges through the exit face. In this way, the angle of incidence of the light that emerges through the exit face is narrowed into a predetermined range according to the inclination angle of the first inclined surfaces. The light that has emerged through the exit face enters, while being refracted, the second prisms provided on the bottom face of the prism sheet through their respective one inclined surfaces, and is reflected on their respective other inclined surfaces, to emerge in a direction substantially orthogonal to the exit face. Light that has been guided through the light guide plate and has emerged through the circumferential face is absorbed in the frame formed of a light-absorbing material.

According to the present invention, in the illumination devices described above, preferably, the frame is formed of black resin.

According to the present invention, in the illumination devices described above, preferably, there is further provided a reflective sheet which faces the rear face of the light guide plate. With this structure, the light that has emerged through the rear face of the light guide plate is reflected on the reflective sheet to return to the light guide plate.

According to the present invention, in the illumination devices described above, preferably, the light source includes a plurality of light sources which are arranged in a row in the longitudinal direction of the entrance face, and third prisms extending in the optical axis direction and arranged side by side in the longitudinal direction of the entrance face are provided on the light guide plate. With this structure, the light emitted from the plurality of light sources arranged in a row in the longitudinal direction of the entrance face enters the light guide plate through the entrance face. The light that has been guided through the light guide plate and has reached the third prisms is reflected while being diffused in the longitudinal direction of the entrance face.

According to yet another aspect of the present invention, a display device is provided with any of the illumination devices structured as described above, and a display panel which is arranged to face the exit face of the light guide plate.

### Advantageous Effects of the Invention

According to one aspect of the present invention, the frame covering the circumferential face of the light guide plate is formed of a light-absorbing material, and the light guide plate includes: a light guide portion having first prisms including first inclined surfaces; a low-refractive-index layer; and second prisms including second inclined surfaces arranged on the rear face. This permits the angle of incidence on the exit face and the rear face of the light guide portion to decrease gradually, so that whatever part of the guided light has angles of incidence in a predetermined rage enters the low-refractive-index layer to emerge through the exit face. This helps reduce the amount of light that emerges through the circumferential face of the light guide plate, and helps prevent the illumination light from having reduced brightness near the frame formed of a light-absorbing material. It is thus possible to make the frame thin, and thereby to reduce the size of the illumination device.

According to another aspect of the present invention, the frame covering the circumferential face of the light guide plate is formed of a light-absorbing material; on the light guide plate, first prisms including first inclined surfaces are provided; and on the bottom face of the prism sheet, second prisms are provided. This permits the angle of incidence on the exit face and the rear face of the light guide plate to decrease gradually, so that whatever part of the guided light has angles of incidences within a predetermined range emerges through the exit face. This helps reduce the amount of light that emerges through the circumferential face of the light guide plate, and thus helps prevent the illumination light from having reduced brightness near the frame formed of a light-absorbing material. It is thus possible to make the frame thin, and thereby to reduce the size of the illumination device.

### BRIEF DESCRIPTION OF DRAWINGS

FIG. 1 is a perspective view showing a display device according to a first embodiment of the present invention;

FIG. 2 is a side sectional view showing the display device according to the first embodiment of the present invention;

FIG. 3 is a perspective view showing a light guide plate of a backlight in the display device according to the first embodiment of the present invention;

FIG. 4 is a sectional view showing a section of the light guide plate of the backlight orthogonal to an entrance face in the display device according to the first embodiment of the present invention;

FIG. 5 is a sectional view showing a section of a light guide portion of the light guide plate of the backlight orthogonal to an entrance face in the display device according to the first embodiment of the present invention;

FIG. 6 is a conceptual diagram showing a travel direction of light guided through the light guide plate of the backlight, as projected on a plane parallel to the entrance face, in the display device according to the first embodiment of the present invention;

FIG. 7 is a side sectional view showing a display device according to a second embodiment of the present invention; and

FIG. 8 is a sectional view showing a section of a light guide plate of a backlight orthogonal to an entrance face in the display device according to the second embodiment of the present invention;

### DESCRIPTION OF EMBODIMENTS

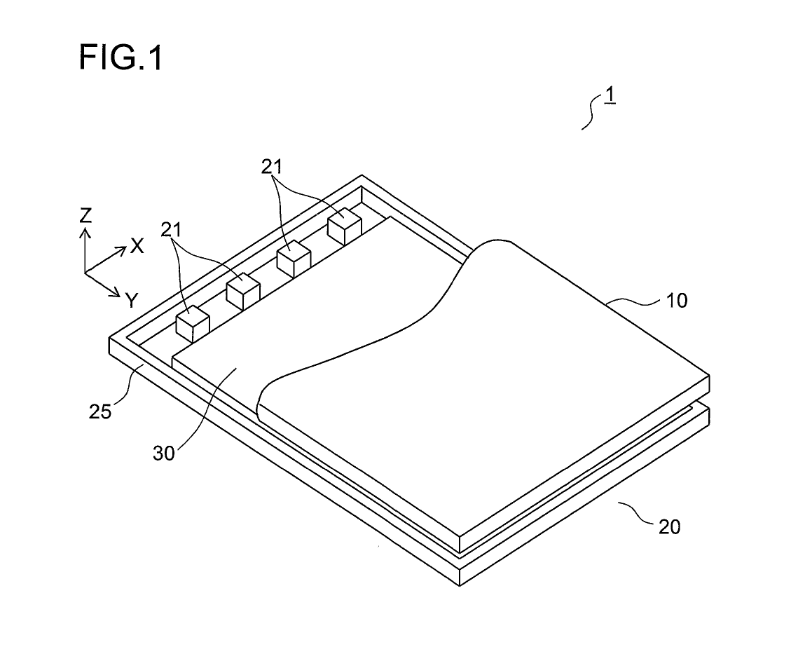

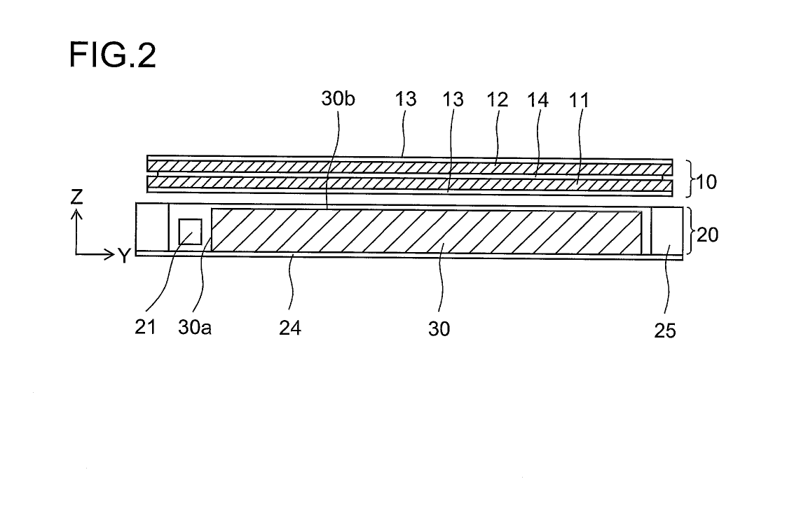

Hereinafter, embodiments of the present invention will be described with reference to the accompanying drawings. FIGS. 1 and 2 are a perspective view and a side sectional view, respectively, showing a display device according to a first embodiment of the present invention. The display device 1 is provided with a display panel 10 and a backlight 20 (illumination device). The display panel 10 comprises a liquid crystal display panel, and is composed of an active matrix substrate 11 including switching devices such as TFTs, a counter substrate 12 disposed to face the active matrix substrate 11, and liquid crystal 14 sealed between them. The entrance-face side of the active matrix substrate 11 is laid with a polarizing film 13, and the exit-face side of the counter substrate 12 is laid with another polarizing film 13.

The backlight 20 includes light sources 21 and a light guide plate 30 arranged inside a frame 25, and an opening in the bottom face of the frame 25 is stopped by a reflective sheet 24. The frame 25 is formed of a light-absorbing material such as a resin-molded member containing a black pigment. The frame 25 may instead be formed by applying a light-absorbing material such as black paint to a base member of resin or metal. The light sources 21 comprises LEDs, and the plurality of light sources 21 are arranged in a row in one direction (X direction).

The light guide plate 30 is formed of transparent resin or the like, in a rectangular shape as seen in a plan view. A side face of the light guide plate 30 faces the light sources 21 to form an entrance face 30a through which the light emitted from the light sources 21 enters. The front face of the light guide plate 30, which faces the display panel 10, forms an exit face 30b.

In the following description, the longitudinal direction of the entrance face 30a is referred to as X direction, the optical axis direction of the light sources 21, which is orthogonal to X direction, is referred to as Y direction, and the direction in which light emerges out of the light guide plate 30, which is orthogonal to both directions X and Y, is referred to as Z direction.

The reflective sheet 24 reflects the light that emerges out of the light guide plate 30 through its rear face back into the light guide plate 30, and serves to improve light use efficiency.

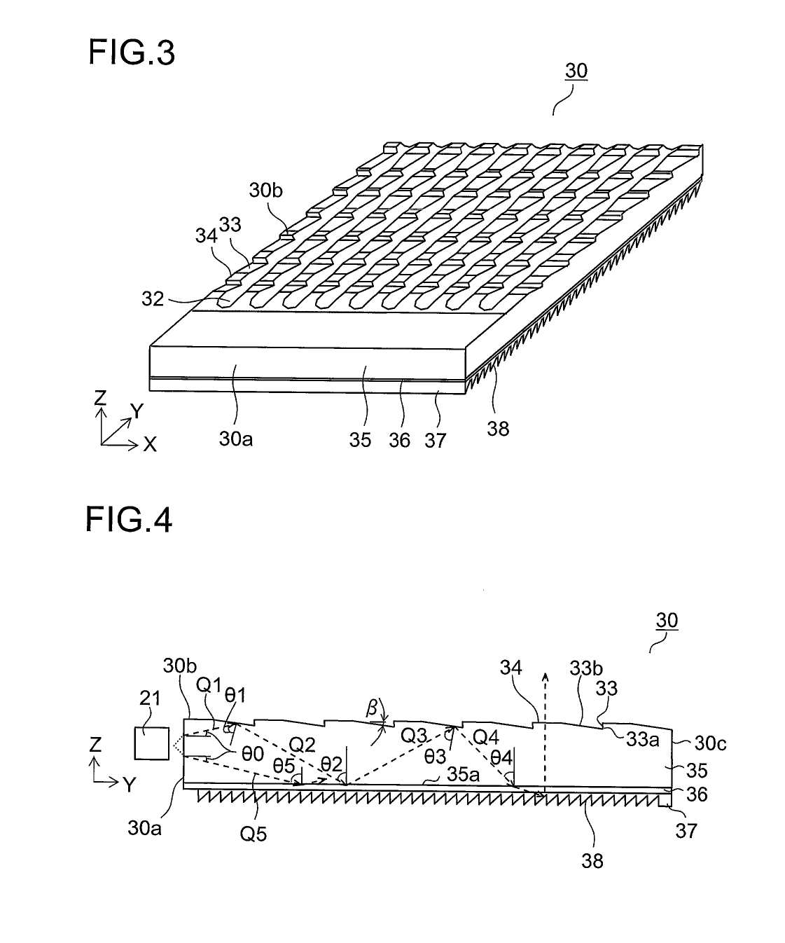

FIGS. 3 and 4 are a perspective view and a side sectional view, respectively, showing the light guide plate 30 of the backlight 20. The light guide plate 30 includes a light guide portion 35, a low-refractive-index layer 36, and a light-collecting portion 37 which are stacked in Z direction. The light guide portion 35 is formed of transparent resin or the like such as acrylic resin or polycarbonate. The light guide portion 35 has an entrance face 30a and an exit face 30b, and guides the light that has entered from the light sources 21.

Preferably, the refractive index n1 of the light guide portion 35 is 1.42 or more, and further preferably 1.59 to 1.65. Forming the light guide portion 35 out of acrylic resin gives it a refractive index n1 of about 1.49. Forming the light guide portion 35 out of polycarbonate gives it a refractive index n1 of about 1.59. When formed of acrylic resin, the light guide portion 35 has higher light transmittance than when formed of polycarbonate.

On the exit face 30b of the light guide portion 35, a plurality of prisms 32 (third prisms) extending in Y direction are arranged side by side in X direction. The prisms 32 are formed as concavities in the exit face 30b, and have a sectional shape describing a circular arc, an elliptic arc, any other curve, a triangle, or the like.

The light that has entered from the light sources 21 through the entrance face 30a is reflected by the prisms 32 while being diffused in the longitudinal direction (X direction) of the entrance face 30a. In this way, the light that has entered from the plurality of light sources 21, each a point light source, is diffused in X direction to produce even illumination light. In a case where a linear light source extending in the longitudinal direction of the entrance face 30a is adopted, the prisms 32 may be omitted.

On the exit face 30b of the light guide plate 30, between neighboring prisms 32, a plurality of prisms 33 (first prisms) are provided which are arranged side by side in Y direction. Between prisms 33 neighboring in Y direction, horizontal surfaces 34 are provided which are parallel to X-Y plane. The prisms 33 may be formed contiguously, with the horizontal surfaces 34 omitted.

The prisms 33 have vertical surfaces 33a which are orthogonal to X-Y plane and inclined surfaces 33b (first inclined surfaces) which are inclined within Y-Z plane. The inclined surfaces 33b are inclined in such a direction as to face the entrance face 30a, and have a predetermined inclination angle β with respect to the direction (Y direction) orthogonal to the entrance face 30a. Preferably, the inclination angle β is 5° or less, and further preferably 0.1° to 3°. Preferably, the length of the inclined surfaces 33b in Y direction is 0.25 mm or less, and further preferably 0.01 mm to 0.10 mm.

The low-refractive-index layer 36 abuts the rear face 35a of the light guide portion 35, and has a lower refractive index than the light guide portion 35. The low-refractive-index layer 36 is formed of acrylate containing fluorine, resin containing hollow particles such as an inorganic nano-sized filler, or the like. Preferably, the refractive index n2 of the low-refractive-index layer 36 is less than 1.42, and further preferably 1.10 to 1.35. Preferably, the refractive index n1 of the light guide portion 35 and the refractive index n2 of the low-refractive-index layer 36 fulfills the relationship n1/n2>1.18.

Forming the low-refractive-index layer 36 out of acrylate containing fluorine gives it a refractive index n2 of about 1.35. Forming the low-refractive-index layer 36 out of resin containing hollow particles gives it a refractive index n2 of 1.30 or less.

The light-collecting portion 37 abuts the low-refractive-index layer 36, and has the same refractive index as, or a higher refractive index than, the low-refractive-index layer 36. Accordingly, the light-collecting portion 37 and the low-refractive-index layer 36 may be formed out of a single member.

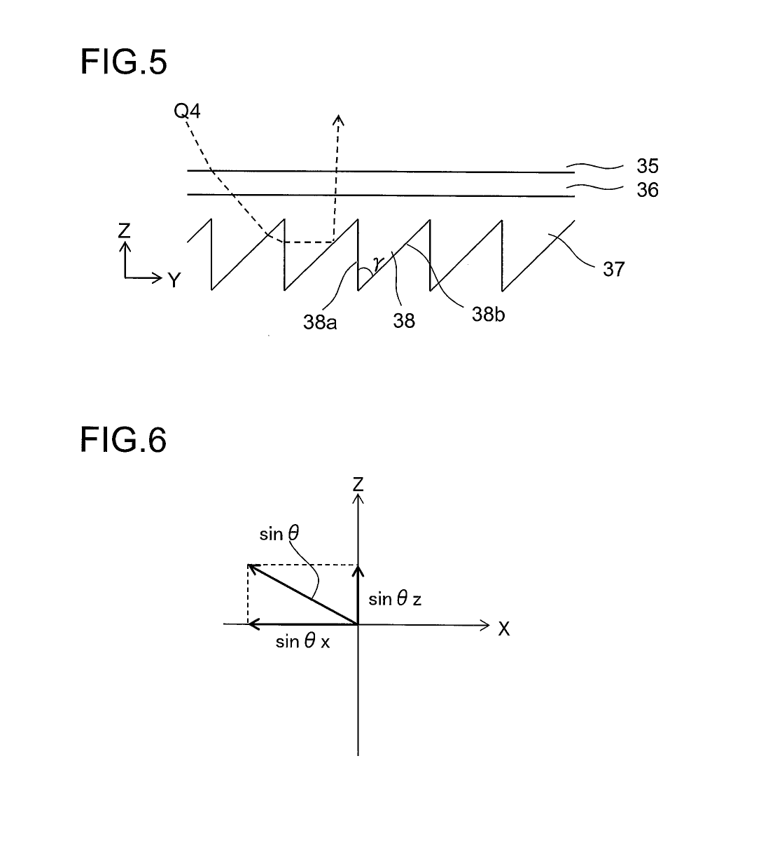

On the rear face of the light-collecting portion 37, a plurality of prisms 38 (second prisms) are provided which extend in X direction and which are arranged side by side in Y direction. As shown in FIG. 5, the prisms 38 have vertical surfaces 38a which are orthogonal to X-Y plane and inclined surfaces 38b (second inclined surfaces) which are inclined within the Y-Z plane. The inclined surfaces 38b are inclined in such a direction as to face the entrance face 30a, and have a predetermined inclination angle γ with respect to Z direction.

Preferably, the length of the inclined surfaces 38b in Y direction is about 0.1 mm or less, and further preferably about 0.01 mm to about 0.025 mm. The inclination angle γ is the vertex angle of the prisms 38, and is preferably 40° to 50°. The vertical surfaces 38a may instead be formed to be inclined with respect to Y direction. In that case, preferably, the vertex angle of the prisms 38 is 40° to 50°.

In the display device 1 structured as described above, the light emitted from the light sources 21 has highest intensity in the frontward direction (Y direction) with respect to the light sources 21, and is spread at an angle of about ±90° in X and Z directions with respect to the frontward direction (Y direction). The light emitted from the light sources 21 is refracted at the entrance face 30a of the light guide portion 35 when entering it. Here, let the angle of refraction be θ0, and let the critical angle between the light guide portion 35 and air be φ1, then θ0<φ1. Here, φ1 equals arcsin (1/n1), and thus, for example, when n1=1.59, then φ1=39°. That is, the spread angle of the light that has entered through the entrance face 30a is ±φ1 in X and Z directions with respect to Y direction.

The light that has entered through the entrance face 30a of the light guide portion 35 is guided by being reflected between the exit face 30b and the rear face 35a. The light that travels from the entrance face 30a to the exit face 30b is incident on either the horizontal surfaces 34 or the inclined surfaces 33b. The light incident on the horizontal surfaces 34 has an angle of incidence of 90°−φ1 or more. The light Q1 incident on the inclined surfaces 33b has an angle of incidence of 90°−φ1−β or more.

Here, light incident on the exit face 30b at an angle of incidence smaller than the critical angle φ1 emerges through the exit face 30b, while light incident at an angle of incidence greater than the critical angle φ1 is totally reflected. The light Q2 reflected on the inclined surfaces 33b is incident on the rear face 35a at an angle of incidence θ2. The angle of incidence θ2 is equal to or greater than 90°−φ1−2·β. Here, light incident on the rear face 35a at an angle of incidence smaller than the critical angle φ2 between the light guide portion 35 and the low-refractive-index layer 36 enters the low-refractive-index layer 36. On the other hand, light incident on the rear face 35a at an angle of incidence greater than the critical angle φ2 is totally reflected. The critical angle φ2 equals=arcsin (n2/n1), and thus, for example, when n1=1.59 and n2=1.35, then φ2=58°.

The light Q3 reflected on the rear face 35a is incident on the exit face 30b. Here, the light incident on the horizontal surfaces 34 has an angle of incidence θ2, and the light incident on the inclined surfaces 33b has an angle of incidence θ3 of 90°−φ1−3·β or more. On the same principle as above, light incident on the exit face 30b at an angle of incidence smaller than the critical angle φ1 emerges through the exit face 30b, and light incident at an angle of incidence greater than the critical angle φ1 is totally reflected.

Here, the light Q4 reflected on the inclined surfaces 33b is incident on the rear face 35a at an angle of incidence θ4. The angle of incidence θ4 is equal to or greater than 90°−φ1−4·β. Light incident on the rear face 35a at an angle of incidence smaller than the critical angle φ2 enters the low-refractive-index layer 36, and light incident on the rear face 35a at an angle of incidence greater than the critical angle φ2 is totally reflected.

That is, while light is guided through the light guide portion 35, reflection on the inclined surfaces 33b causes the angle of incidence on the exit face 30b and the rear face 35a to decrease gradually. The angle of incidence on the interface between the light guide portion 35 and the low-refractive-index layer 36 decreases in steps of 2·β until it becomes smaller than the critical angle φ2, when the light enters the low-refractive-index layer 36. Thus, the angle of incidence of the light that travels out of the light guide portion 35 into the low-refractive-index layer 36 is in the range of φ2 to φ2−2·β.

The light that has entered the low-refractive-index layer 36 passes through the low-refractive-index layer 36 and enters the light-collecting portion 37. Here, the refractive index n3 of the light-collecting portion 37 is equal to or higher than the refractive index n2 of the low-refractive-index layer 36, and thus total reflection does not occur at the interface between the low-refractive-index layer 36 and the light-collecting portion 37.

As shown in FIG. 5, the light that has entered the light-collecting portion 37 is incident on the inclined surfaces 38b of the prisms 38. Light that is incident on the prisms 38 at an angle of incidence greater than the critical angle φ3 between the light-collecting portion 37 and air is totally reflected in the direction of the exit face 30b. The critical angle φ3 equals arcsin (1/n3). For example, when n1=n3=1.59, then φ3=39°; when n1=1.59 and n2=n3=1.35, then φ3=48°.

Light incident on the inclined surfaces 38b at an angle of incidence smaller than the critical angle φ3 is refracted to emerge out of the light-collecting portion 37, and is then refracted at the vertical surfaces 38a to enter the light-collecting portion 37 again. While light travels out of and into the light-collecting portion 37 repeatedly, through refraction, the angle of incidence on the inclined surfaces 38b increases gradually until the light is totally reflected on the inclined surfaces 38b.

The light reflected on the inclined surfaces 38b emerges through the exit face 30b. In this way, the directivity angle of the light emerging through the exit face 30b is narrowed in the direction (Y direction) orthogonal to the ridge lines of the prisms 33 and 38.

Likewise, in FIG. 4, the light Q5 that travels from the incidence face 30a toward the rear face 35a of the light guide portion 35 is repeatedly reflected between the exit face 30b and the rear face 35a and enters the low-refractive-index layer 36. It is then reflected on the inclined surfaces 38b of the prisms 38 to emerge through the exit face 30b.

Thus, with respect to the light guided through the light guide portion 35, the angle of incidence on the low-refractive-index layer 36 decreases in steps of 2·β, so that one part after another of the light enters the low-refractive-index layer 36 to emerge through the exit face 30b. This helps reduce the amount of light that emerges through the end face 30c (see FIG. 4) facing away from the entrance face 30a.

Consequently, even when the frame 25 is formed of a light-absorbing material, little light is absorbed in it. This helps prevent the illumination light from having reduced brightness near the frame 25. It is thus possible to make the frame 25 thin to achieve frame width reduction in the backlight 20, and thereby to reduce the size of the backlight 20 and hence of the display device 1.

Next, a description will be given of how the spread in X direction of the light guided through the light guide portion 35 is suppressed. Let the angle of the travel direction, with respect to Y direction, of the light guided trough the light guide portion 35 be θ. Then, for the angle θ of the light (Q1, Q5) that has entered through the entrance face 30a, expression (1) below holds. Moreover, light that fulfills expression (2) below enters the low-refractive-index layer 36. Though the following description deals with the light (Q1, Q5) that has entered through the entrance face 30a, it applies equally to the light (Q2, Q3, Q4) that has been reflected repeatedly.

θ≦φ1=arcsin(1/n1) (1)

90°−0<φ2=arcsin(n2/n1) (2)

FIG. 6 is a diagram showing the travel direction of the light that has entered the light guide portion 35, as projected on a plane parallel to the entrance face 30a. With respect to the light that has entered the light guide portion 35, the Z-direction spread component is represented by θz, and the X-direction spread component is represented by θx. The angle of incidence of the light on the low-refractive-index layer 36 is 90°−θz. The condition under which light enters the low-refractive-index layer 36 is 90°−θz<φ2, and since 0<90°−θz<90°, expression (3) below is obtained. From FIG. 6, expression (4) below is obtained.

cos(90°−θz)=sin θz>cos φ2 (3)

sin² θx=sin² θ−sin² θz (4)

Here, expressions (1) and (3) give sin θ≦sin φ1 and cos φ2<sin θz≦sin φ1; hence, by use of expression (4), expression (5) below is obtained.

0≦sin² θx<sin² φ1−cos² φ2 (5)

For example, when n1=1.59 and n2=1.35, then the range in which θx falls is 0°≦θx<19.95°, and in this way it is possible to suppress the spread of light in X direction. Incidentally, the effect of suppressing the spread of light in X direction is slightly lessened by the prisms 32. However, by increasing the inclination angle of the inclined surfaces of the prisms 32, it is possible to mostly retain the effect of suppressing the spread of light in X direction.

In this embodiment, the frame 25 covering the circumferential face of the light guide plate 30 is formed of a light-absorbing material, and the light guide plate 30 includes: a light guide portion 35 having prisms 33 (first prisms) including inclined surfaces 33b (first inclined surfaces); a low-refractive-index layer 36; and prisms 38 (second prisms) including inclined surfaces 38b (second inclined surfaces) arranged on the rear face.

This permits the angle of incidence on the exit face 30b and the rear face 35a of the light guide portion 35 to degrease gradually, so that whatever part of the guided light has angles of incidence in a predetermined rage enters the low-refractive-index layer 36 to emerge through the exit face 30b. This helps reduce the amount of light that emerges through the end face 30c of the light guide plate 30, and helps prevent the illumination light from having reduced brightness near the frame 25 formed of a light-absorbing material. It is thus possible to make the frame 25 thin, and thereby to reduce the size of the backlight 20 and hence of the display device 1.

Moreover, the frame 25 formed of a light-absorbing material can easily be formed of black resin.

Moreover, owing to the provision of the plurality of light sources 21 in a row in X direction and of the prisms 32 (third prisms) which extend in Y direction and which are arranged side by side in the X direction on the exit face 30b of the light guide plate 30, it is possible to produce even illumination light by diffusing in X direction the light that has entered from the plurality of light sources 21, each a point light source.

In this embodiment, the prisms 33 may be provided at the interface between the light guide portion 35 and the low-refractive-index layer 36. The prisms 32 may be provided to protrude from the exit face 30b of the light guide plate 30.

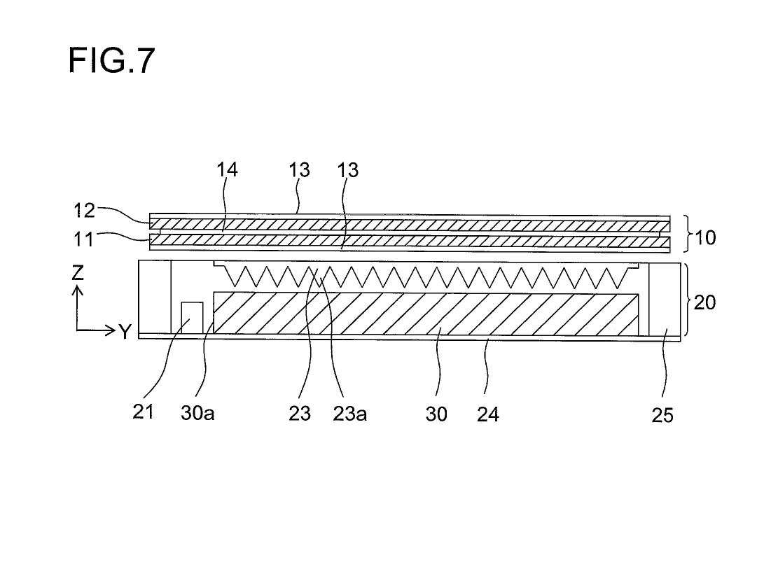

FIG. 7 is a side sectional view of a display device 1 according to a second embodiment of the present invention. Such parts as find their counterparts in the first embodiment described previously and shown in FIGS. 1 to 6 are identified by common reference signs. The second embodiment differs from the first in that the light guide plate 30 is differently shaped, and that a prism sheet 23 is provided. In other respects, the structure here is similar to that in the first embodiment.

The prism sheet 23 is arranged to face the exit face 30b of the light guide plate 30, and is provided with, on its bottom face (on the light guide plate 30 side), a plurality of prisms 23a (second prisms) which extend in X direction and which are arranged side by side in Y direction. The prisms 23a are formed to have a sectional shape substantially describing a isosceles triangle, so as to narrow, in the direction (Y direction) orthogonal to their ridge lines, the directivity angle of the light that emerges through the exit face 30b. This helps improve brightness at the front of the exit face 30b.

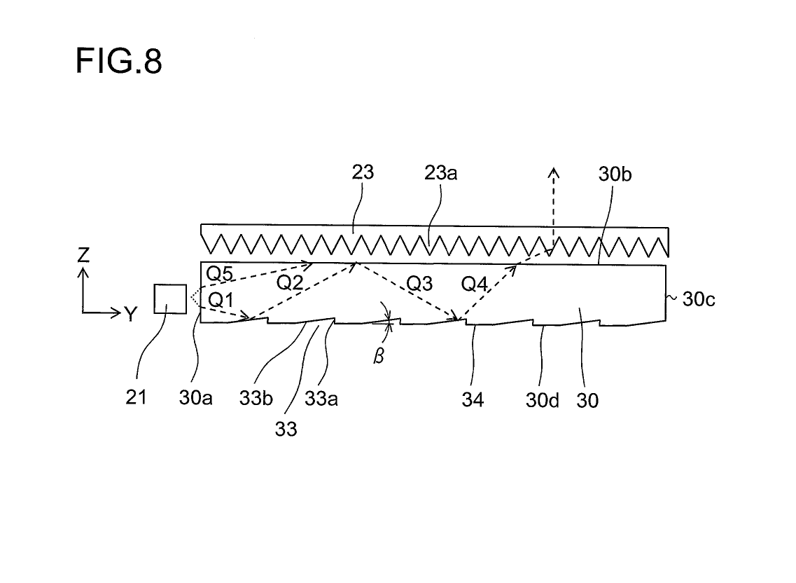

FIG. 8 is a side sectional view showing the details of the light guide plate 30 and the prism sheet 23. On the rear face 30d of the light guide plate 30, a plurality of prisms 33 (first prisms) like those in the first embodiment are arranged side by side in Y direction. Between prisms 33 neighboring in Y direction, horizontal surfaces 34 are provided which are parallel to X-Y plane. The prisms 33 may be formed contiguously, with the horizontal surfaces 34 omitted.

The prisms 33 have vertical surfaces 33a which are orthogonal to X-Y plane and inclined surfaces 33b (first inclined surfaces) which are inclined within the Y-Z plane. The inclined surfaces 33b are inclined in such a direction as to face the entrance face 30a, and have a predetermined inclination angle β with respect to the direction (Y direction) orthogonal to the entrance face 30a.

On the rear face 30d of the light guide plate 30, as in the first embodiment, prisms 32 (third prisms, see FIG. 3) which neighbor the prisms 33 in X direction and which extend in Y direction are formed as concavities. The prisms 32 (third prisms) may be formed to protrude from the rear face 30d of the light guide plate 30.

In the display device 1 structured as described above, the light emitted from the light sources 21 enters the light guide plate 30 through the entrance face 30a. The light that has entered the light guide plate 30 is guided by being reflected on the exit face 30b and the rear face 30d. Here, reflection on the inclined surfaces 33b causes the angle of incidence on the exit face 30b and the rear face 30d to decrease gradually. The angle of incidence on the exit face 30b decreases in steps of 2·β until it becomes smaller than the critical angle φ1, when the light emerges through the exit face. Thus, the angle of incidence of the light that emerges through the exit face 30b is in the range of φ1 to φ1−2·β.

The light that has emerged out of the light guide plate 30 enters the prism sheet 23. Here, since the prisms 23a are provided on the bottom face of the prism sheet 23, light is prevented from being reflected on both inclined surfaces of the respective prisms 23a to return to the light guide plate 30 as in the conventional structure. The light that has entered the prism sheet 23 is reflected on one inclined surface of the respective prisms 23a to be directed upward. Thus, the illumination light has its directivity angle narrowed by the prisms 23a in the direction (Y direction) orthogonal to their ridge lines, and then illuminates the display panel 10. The illumination light is transmitted through predetermined pixels of the display panel 10, so as to display an image on the display panel 10.

As described above, with respect to the light guided through the light guide plate 30, the angle of incidence on the exit face 30b decreases in steps of 2·β, so that one part after another of the light emerges through the exit face 30b. This helps reduce the amount of light that emerges through the end face 30c (see FIG. 7) facing away from the entrance face 30a.

Consequently, even when the frame 25 is formed of a light-absorbing material, little light is absorbed in it. This helps prevent the illumination light from having reduced brightness near the frame 25. It is thus possible to make the frame 25 thin to achieve frame width reduction in the backlight 20, and thereby to reduce the size of the backlight 20 and hence of the display device 1.

In this embodiment, the frame 25 covering the circumferential face of the light guide plate 30 is formed of a light-absorbing material; on the light guide plate 30, prisms 33 (first prisms) including inclined surfaces 33b (first inclined surfaces) are provided; and on the bottom face of the prism sheet 23, prisms 23a (second prisms) are provided. This permits the angle of incidence on the exit face 30b and the rear face 30d of the light guide plate 30 to decrease gradually, so that whatever part of the guided light has angles of incidences within a predetermined range emerges through the exit face 30b. This helps reduce the amount of light that emerges through the end face 30c of the light guide plate 30, and thus helps prevent the illumination light from having reduced brightness near the frame 25 formed of a light-absorbing material. It is thus possible to make the frame 25 thin, and thereby to reduce the size of the backlight 20 and hence of the display device 1.

In both the first and second embodiments, the backlight 20 may be used as a lighting appliance for lighting indoors and outdoors.

### INDUSTRIAL APPLICABILITY

The present invention finds wide application in illumination devices incorporating light guide plates, such as backlights and lighting appliances, and in display devices employing illumination devices, such as liquid crystal display devices.

### LIST OF REFERENCE SIGNS

1 display device

10 display panel

11 active matrix substrate

12 counter substrate

13 polarizing film

20 backlight (illumination device)

21 light source

23 prism sheet

23a prism (second prism)

24 reflective sheet

30 light guide plate

30a entrance face

30b exit face

32 prism (third prism)

33 prism (first prism)

33a, 38a vertical surface

33b, 38b inclined surface

34 horizontal surface

35 light guide portion

36 low-refractive-index layer

37 light-collecting portion

38 prism (second prism)

1. An illumination device comprising:
a light source;
a light guide plate having at one end face thereof an entrance face facing the light source, the light guide plate guiding light that has entered through the entrance face to emit illumination light through an exit face arranged at a front face of the light guide plate; and
a frame covering a circumferential face of the light guide plate,
wherein the light guide plate has
a light guide portion which has the entrance face and the exit face, and on which first prisms including first inclined surfaces facing, with an inclination, the entrance face are arranged side by side in an optical axis direction of the light source,
a low-refractive-index layer abutting a rear face of the light guide portion and having a lower refractive index than the light guide portion, and
a light-collecting portion formed on a face of the low-refractive-index layer facing away from the exit face and on which second prisms including second inclined surfaces facing, with an inclination, the entrance face are arranged side by side in the optical axis direction, and
wherein the frame is formed of a light-absorbing material.

2. An illumination device comprising:
a light source;
a light guide plate having at one end face thereof an entrance face facing the light source, the light guide plate guiding light that has entered through the entrance face to emit illumination light through an exit face arranged at a front face of the light guide plate;
a prism sheet arranged to face the exit face; and
a frame covering a circumferential face of the light guide plate,
wherein, on the light guide plate, first prisms including first inclined surfaces facing, with an inclination, the entrance face are arranged side by side in an optical axis direction of the light source,
wherein, on the prism sheet, second prisms facing the light guide plate and extending in a longitudinal direction of the entrance face are arranged side by side in the optical axis direction, and
wherein the frame is formed of a light-absorbing material.

3. The illumination device according to claim 1, wherein the frame is formed of black resin.

4. The illumination device according to claim 1, further comprising a reflective sheet facing a rear face of the light guide plate.

5. The illumination device according to claim 1,
wherein the light source comprises a plurality of light sources arranged in a row in a longitudinal direction of the entrance face, and
wherein third prisms extending in the optical axis direction and arranged side by side in the longitudinal direction of the entrance face are provided on the light guide plate.

6. A display device comprising:
the illumination device according to claim 1; and
a display panel arranged to face the exit face of the light guide plate.

7. The illumination device according to claim 2, wherein the frame is formed of black resin.

8. The illumination device according to claim 2, further comprising a reflective sheet facing a rear face of the light guide plate.

9. The illumination device according to claim 2,
wherein the light source comprises a plurality of light sources arranged in a row in a longitudinal direction of the entrance face, and
wherein third prisms extending in the optical axis direction and arranged side by side in the longitudinal direction of the entrance face are provided on the light guide plate.

10. A display device comprising:
the illumination device according to claim 2; and
a display panel arranged to face the exit face of the light guide plate.
